(19) United States
(12) Patent Application Publication
(10) Pub. No.: US 2009/0060672 A1
(43) Pub. Date: Mar. 5, 2009

(54) Multiple Operation Gear Manufacturing Apparatus With Common Work Axis

(76) Inventors: Brian M. Fitzgerald, Cazenovia, NY (US); Jeffrey A. Rynders, McGraw, NY (US)

Correspondence Address: HARNESS, DICKEY & PIERCE, P.L.C., P.O. BOX 828, BLOOMFIELD HILLS, MI, 48303, US

(21) Appl. No.: 12/182,367

(22) Filed: Jul. 30, 2008

Related U.S. Application Data
(63) Continuation-in-part of application No. 11/051,806, filed on Feb. 4, 2005, now abandoned.

(51) Int. Cl. B23F 17/00

(52) U.S. Cl. 409/31

(57) ABSTRACT

A gear production apparatus for producing a gear from a blank includes a blank retainer rotatably supporting and selectively driving the blank about a work axis. An axially moveable first stock supports a first tool for rotation about a first axis extending substantially perpendicular to the work axis. An axially moveable second stock supports a second tool for rotation about the second axis. The second tool is moveable in two additional degrees of freedom such that the second axis is rotatable about a third axis and the second tool is axially translatable along the second axis. The second tool is moveable with the second stock along a line extending substantially perpendicular to and intersecting the work axis. The first stock is moveable to engage the first tool with the blank to form rough teeth. The second stock is moveable to engage the second tool with the blank.

### CROSS-REFERENCE TO RELATED APPLICATIONS

This application is a continuation-in-part of U.S. patent application Ser. No. 11/051,806 filed on Feb. 4, 2005. The disclosure of the above application is incorporated herein by reference.

### FIELD

The present disclosure generally relates to component manufacture methods, machinery and tooling and more particularly to an improved gear manufacture method, tooling and machinery.

### BACKGROUND

Mass production of components, such as gears and the like, typically includes a series of machines integrally linked in a production line. Such machines may include cutters, grinders, shavers, heat treat and the like. Generally, a raw component is loaded at the beginning of the line and each machine performs a specific manufacturing process on the raw component, ultimately producing a finished product. Each step of the process includes an associated cycle-time. The cycle-time is the amount of time it takes a particular machine to perform its process, including loading and unloading of a component. The cycle-time translates directly into manufacturing costs and thus component price.

In addition to cycle-times, each machine has associated costs. The initial cost is the capital investment required to purchase the machine. Other costs are incurred throughout the life of the machine. These on-going costs include maintenance, replacement parts, general running costs (electricity, lubricant, etc.) and the like.

Gear hobbing is one of a variety of methods employed for manufacturing gears and is generally used in mass production for rough cutting teeth in gear blanks. In gear hobbing, the cutting tool is termed a ‘hob”. Generally, hobs are cylindrical in shape and are greater in length than in diameter. The cutting teeth of a hob extend radially from the cylindrical body and follow a helical path about the hob, along the length of the hob. Hobbing is a continuous process in which the hob and gear blank rotate in timed relation to one another. The cutting action is continuous in one direction until the gear is complete.

The hob is fed across the circumferential face of a gear blank at a uniform rate. As the hob moves across the circumferential face of the gear blank, both the hob and the gear blank rotate about their respective axes. As the hob cuts the gear blank, tooth profiles gradually form within the circumferential face of the blank and the teeth gradually take shape across the gear face.

Accuracy and production requirements dictate the type of hob to be used. Hob types vary from single-thread to double-thread or more in multiple. A single-thread hob makes one revolution as the gear being cut rotates the angular distance of one tooth and one space. For example, for producing a spur gear having 49 teeth, a single-thread hob rotates 49 times for one revolution of the gear blank. Similarly, when using a double-thread hob, the hob rotates 49 times for two revolutions of the gear blank. Multiple threads increase the rotational speed of the gear blank accordingly. However, certain limitations are inherent in using multiple-thread hobs.

The number of threads is a function of the intended purpose. Although not efficient for mass production, single-thread hobs may be used for both roughing and finishing. Multiple-thread hobs are commonly used for roughing. As a result of the multiplication effect of multiple-thread hobs, speed increases, thus providing savings in cycle-time. However, compared to single-thread hobs, multiple-thread hobs leave much larger feed marks on the tooth profiles of the gear teeth. For example, using a single-thread hob, each tooth of the hob cuts every tooth space in the gear blank. A double-thread hob contacts every other tooth space during any single revolution of the gear blank.

Various feed directions of the hob, relative to the gear blank, are employable and are dependent upon the type of gear to be cut. The hob feed directions include axial, oblique, infeed (or plunge) and tangential. Generally, the hob is fed into contact with the gear blank as opposed to the gear blank being fed into contact with the hob. Axial hob feeding includes the hob being fed into the gear blank along a path that is parallel to the axis of rotation of the gear blank. In oblique hobbing, the hob path is at an angle relative to the axis of rotation of the gear blank. In this manner, the cutting action is distributed along an increased length of the hob as it is fed across the gear blank. In infeed hobbing, the hob is fed radially inward into the gear blank. With tangential hobbing, the hob is fed tangentially across the gear blank.

Besides rough forming of gear teeth, other forming processes may be required for a particular gear design. For example, typical gear designs dictate that a chamfer be formed on each side of the individual gear teeth. To achieve this, a second roughing process is required using additional tools and machines. Generally, a chamfering tool is used and includes a circumferential face having a set of mating gear teeth recessed between chamfer forming faces. The rough gear and tool are pressed into engagement with one another, wherein the rough gear blank meshes with the mating gear teeth of the chamfering tool and both the tool and the rough gear rotate in unison. As the rough gear and chamfering tool rotate, the chamfer forming faces displace material at each side of the individual gear teeth, thus forming a chamfer on each side of the individual gear teeth.

Having thus formed the chamfers, the displaced material must be removed from the rough gear in a process known as deburring. Deburring of the rough gear is typically achieved using a third process that implements a third tool for cutting away the displaced material. It is, however, known in the art to combine the chamfer forming and deburring tools. A single chamfer/debur tool is constructed similarly as described above for the chamfer tool, however, further includes cutters or skiving discs associated with the chamfer forming faces. The skiving discs remove the displaced material immediately after the corresponding forming face forms the chamfer.

To finish the gear, a finishing process is performed. Gear finishing processes are used for improving accuracy and uniformity of the gear teeth. The degree of accuracy and, thus, the finishing process required is dependent upon the functional requirements of the gear.

Gear shaving is the most commonly used method of finishing gear teeth prior to hardening. Gear shaving is a cutting process, whereby material is removed from the profiles of each gear tooth by a cutter. The cutter may vary in form, typically resembling a gear or rack depending upon whether a rotary or a rack gear shaving method is used.

Typical gear production lines include a series of machines for performing each of the above-described processes. As such, each machine requires an initial capital investment cost and the other associated costs described above. Furthermore, general production cycle-time of a production line, having multiple machines, includes transfer time between machines. Key elements of manufacturing costs include, but are not limited to, the number of machines required, the number of processes required, the set-up time between the processes and the overall cycle-time of each work-piece. As manufacturers seek to improve overall operational costs reduction in any one of these areas is sought. Manufacturers seek to reduce the amount of machines required for production, thereby reducing capital and maintenance costs, as well as reducing the cycle-time for producing each component, thus increasing the efficiency of the complete process.

A majority of state-of-the-art machine tools are computer numerically controlled machines or “CNC’ machines. Such machines use computer control for both machine operation and set-up. Computers further enable a series of machines that perform separate functions to work in concert to perform several operations on a work piece and to mass produce final products. Each machine, however, must be independently programmed by an operator prior to processing a new work piece design. Because each machine is independently programmed, set-up time and thus, overall manufacture time is less efficient than desired. As a result, overall manufacture cost and product cost is higher than desired.

Therefore, it is desirable in the industry to provide improved machinery for producing components, such as gears. The improved machinery should limit the need for additional, supporting machines, reduce the overall capital investment and maintenance costs, as well as reduce the cycle time of component manufacture.

### SUMMARY

A gear production apparatus for producing a gear from a blank includes a blank retainer rotatably supporting and selectively driving the blank about a work axis. An axially moveable first stock supports a first tool for rotation about a first axis extending substantially perpendicular to the work axis. An axially moveable second stock supports a second tool for rotation about the second axis. The second tool is moveable in two additional degrees of freedom such that the second axis is rotatable about a third axis and the second tool is axially translatable along the second axis. The second tool is moveable with the second stock along a line extending substantially perpendicular to and intersecting the work axis. The first stock is moveable to engage the first tool with the blank to form rough teeth. The second stock is moveable to engage the second tool with the blank.

Furthermore, a gear production apparatus for producing a gear from a blank includes a blank retainer supporting the blank for rotation about a work axis. An axially moveable first stock supports a first tool for rotation about a first axis extending perpendicular to the work axis. An axially moveable second stock includes an independently moveable first spindle supporting the second tool for rotation about a second axis. The first spindle is rotatable about a third axis and is axially translatable along the second axis. An axially moveable third stock includes an independently moveable second spindle supporting a third tool for rotation about a fourth axis. The second spindle is axially translatable along the fourth axis and rotatable about a fifth axis. The first stock is moveable to engage the first tool with the blank to form rough teeth in the blank. The second stock is moveable to engage the second tool with the blank. The third stock is moveable to engage the third tool with the blank.

### BRIEF DESCRIPTION OF THE DRAWINGS

The present disclosure will become more fully understood from the detailed description and the accompanying drawings, wherein:

FIG. 1 is a perspective view of a gear manufacturing apparatus according to the principles of the present disclosure;

FIG. 2 is a plan view of a combination hob and shave tool of the gear apparatus of FIG. 1;

FIG. 3 is a plan view of a combination chamfer/debur tool of the gear manufacturing apparatus of FIG. 1;

FIG. 4 is a plan view of a combination hob, shave and chamfer/debur tool of the gear manufacturing apparatus of FIG. 1;

FIG. 5 is a plan view of an alternative gear manufacturing apparatus according to the principles of the present disclosure;

FIG. 6 is a detailed plan view of the alternative gear manufacturing apparatus of FIG. 5; and

FIG. 7 is a fragmentary side view of the apparatus shown in FIG. 6 taken along line U with the hob being removed.

### DETAILED DESCRIPTION OF THE PREFERRED EMBODIMENTS

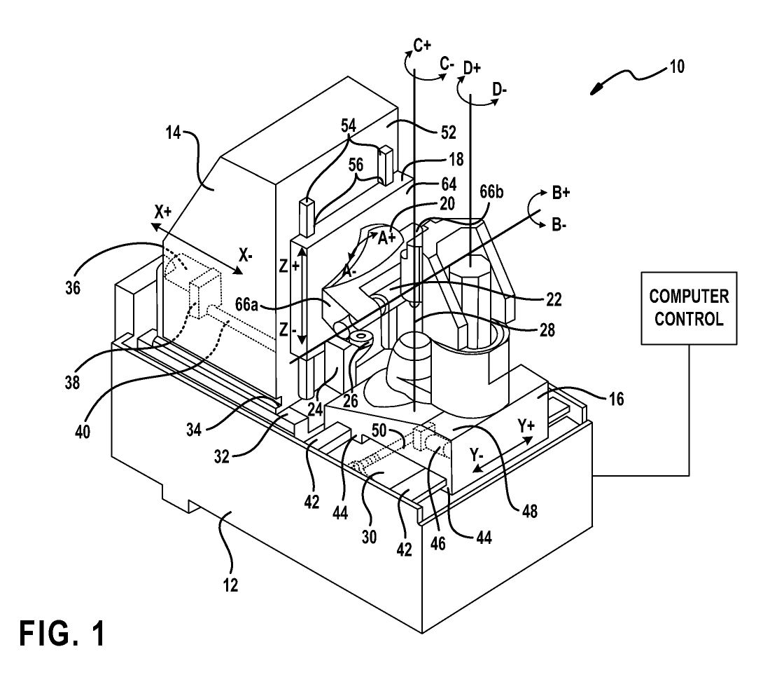

With particular reference to FIG. 1, an exemplary embodiment of a four-process manufacturing apparatus 10 (the apparatus) is shown. The apparatus 10 of the exemplary embodiment is provided for the manufacture of gears. However, it should be noted that the apparatus 10 is preferably variable for manufacture of any one of a number of alternative components. The apparatus 10 and its related components, described in detail below, are preferably CNC controlled by any one of a number of controllers (not shown) commonly known in the art. The controller is programmable for manufacturing a variety of components and/or component designs. It is foreseen that the controller is also programmable to simultaneously control operation of the rectilinear and rotary movement of the various stocks and spindles described herein.

The apparatus 10 includes a generally rectangular, solid metal base 12 providing a solid support structure for the various apparatus components described herein. First and second stocks 14,16 are included and are each slidably engaged with the base 12. A third stock 18 slidably engages the first stock 14. A fourth stock 20 is rotatably supported by the third stock 18 and operatively supports a combination hob/shave tool 22. A fifth stock 24 is positioned between the first and second stocks 14,16 and operatively supports a combination chamfer/debur tool 26. The second stock 16 includes a retention device 28 for operably retaining a work-piece (not shown) during manufacture. Rectilinear movement of the various sliding stocks described above is achieved by respective drive motors that act through speed reducing gearing and recirculating ball screw drives. It is also anticipated that direct drive motors and/or linear motors can be implemented.

The base 12 includes a top surface 30, to which the first and second stocks 14,16 are slidably interfaced. The first stock 14 is slidable along a first axis X that runs along the length of the base 12. The second stock 16 is slidable along a second axis Y that is generally perpendicular to the first axis X, running across the width of the base 12. The base 12 includes a first pair of rails 32 disposed along a length of and extending upward from the top surface 30. The first pair of rails 32 slidably engages a corresponding pair of rails 34 disposed on a bottom surface of the first stock 14. Rectilinear movement of the first stock 14 is imparted by a drive motor 36 acting through a gear reduction unit 38 and a ball screw 40. The drive motor 36 is controllable for selectively sliding and locating the first stock 14 along the axis X. The base 12 further includes a second pair of rails 42 disposed across a width of and extending upward from the top surface 30. The second pair of rails 42 slidably engages a corresponding pair of rails 44 disposed on a bottom surface of the second stock 16. Rectilinear movement of the second stock 16 is imparted by a drive motor 46 acting through a gear reduction unit 48 and a ball screw 50. The drive motor 46 is controllable for selectively sliding and locating the second stock 16 along the axis Y.

The first stock 14 includes a front face 52 to which the third stock 18 is slidably attached. The front face 52 of the first stock 14 includes a pair of rails 54 extending therefrom that slidably engage a corresponding pair of rails 56 disposed on a back face of the third stock 18. The third stock 18 is slidable along a vertical axis Z of the front face 52. A drive motor (not shown) acting through a gear reduction unit (not shown) and ball screw (not shown) are provided for selectively sliding and locating the third stock 18 along the axis Z, relative to the second stock 16.

The third stock 18 further includes a front face 64, to which the fourth stock 20 is rotatably attached. The fourth stock 20 is selectively rotatable about a rotational axis A and includes first and second arms 66a, 66b extending therefrom, for operably retaining the combination hob/shave tool 22 therebetween. A positioning motor (not shown) is provided for rotationally positioning the fourth stock 20 about the rotational axis A. The hob/shave tool 22 is rotatably driven, by a drive motor (not shown), about an axis B that is generally parallel to the front face 64 of the third stock 18 and is initially generally perpendicular to the axis A. The rotational position of the fourth stock 20 and the lateral position of the third stock 18 are controlled by the controller.

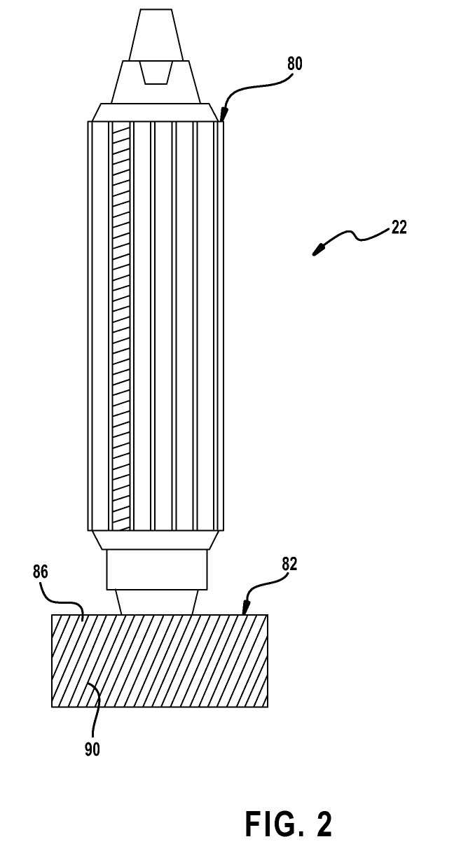

With reference to FIG. 2, the hob/shave tool 22 includes a hob 80 and a shaver 82 affixed to one another. It should be noted, however that detachment of the hob 80 and shaver 82 is anticipated, whereby a portion of the hob/shave tool 22 may be replaced if worn before the other portion. The hob 80 is generally cylindrical in shape and includes a plurality of hob teeth 84 radially extending from a circumferential surface. The hob teeth 84 follow a generally helical path along the length of the hob 80. The shaver 82 is generally gear shaped including a plurality of gear teeth 86 and a clearance hole (not shown) through the base of each tooth 86. The gear teeth 86 are serrated to provide a series of cutting edges 90. The serrations extend from the tip of the tooth 86 into the clearance hole.

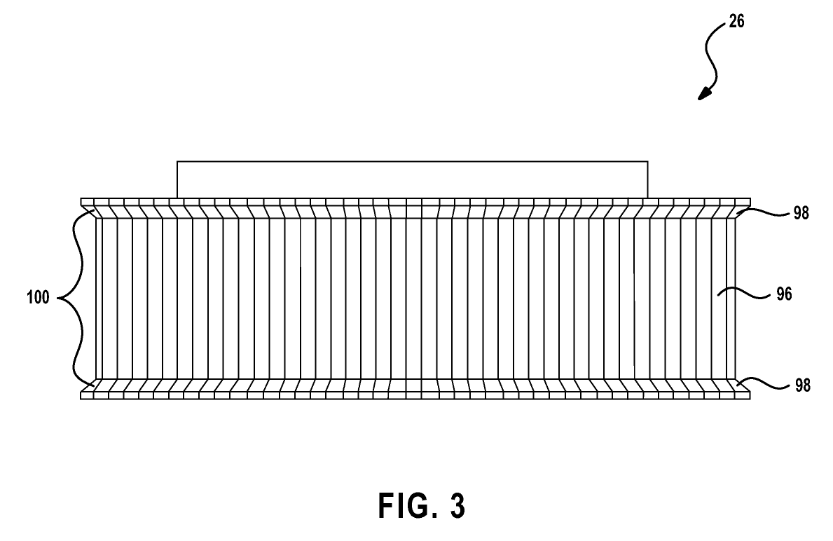

With reference to FIG. 3, the chamfer/debur tool 26 is operatively supported by the fifth stock 24 and is rotatably driven by a drive motor (not shown) through a gear unit (not shown). With reference to FIG. 3, the chamfer/debur tool 26 is a generally gear shaped tool having a series of gear teeth 96 extending radially from an outside circumferential surface. At the ends of each of the gear teeth 96 is located a chamfer surface 98 that serves to produce a chamfer. Positioned adjacent each chamfer surface 98 is a skiving disc 100 that cuts away the displaced material for deburring the chamfer of the gear teeth.

As mentioned previously, the second stock 16 includes the retention device 28 for selectively holding a work-piece. It is foreseen that the work-piece may be either manually loaded, by an operator, or alternatively, an automated loading system (not shown) may be included for loading the work-piece into the apparatus 10. The work-piece is held by the retention device 28 such that it is freely rotatable about a rotational axis C. The rotational axis C is generally parallel to the front face 64 of the third stock 18 and perpendicular to the top surface 30 of the base 12. Rotation of the work-piece about the axis C is driven by the tools as described in further detail herein. It is also foreseen that a loading carousel (not shown) is rotatable about an axis D.

With reference to the Figures, a method of manufacturing a gear and the corresponding operation of the apparatus 10 will be described in detail. Manufacturing of a gear includes the steps of: loading a gear blank (work-piece), hobbing rough gear teeth into the work-piece, chamfering and deburring the rough gear-teeth, finishing the gear teeth via shaving, and unloading the finished work-piece. As used herein, the term operates refers to one of several machining operations known in the art including, but not limited to hobbing, shaving, chamfering and deburring.

Initially, a work-piece, in the form of a cylindrical gear blank, is loaded into the retention device 28 of the second stock 16. Once locked in position, the controller initiates the hobbing step, whereby the hob/shave tool 22 is rotatably driven and fed into contact with the work-piece and operates on the work-piece to form rough gear teeth in the work-piece. The preferred feeding method of the present disclosure is infeed or plunge. The hob/shave tool 22 is infed via forward movement of the first stock 14 along the axis X, relative to the second stock 16. As the hob/shave tool 22 contacts a circumferential surface of the work-piece, the hob teeth 84 begin cutting corresponding teeth into the circumferential surface. The hob/shave tool 22 is rotatably driven in a synchronized manner with the work-piece. More specifically, the hob/shave tool 22 and the work-piece are driven about their respective axis and the respective rotation therebetween is synchronized by the CNC control. As the hob teeth 84 cut the helical pattern of the gear teeth, the work-piece to rotates about the axis C. In this manner, the gear teeth are cut into the complete circumferential surface of the work-piece. The number of revolutions of the hob/shave tool 22, and thus the work-piece, is dependent upon the number of threads of the hob/shave tool 22. Upon completion of rough gear tooth formation, the hob/shave tool 22 is withdrawn through reverse movement of the first stock 14 along the axis X, relative to the second stock 16.

After the hob/shave tool 22 has been withdrawn, the chamfer/debur tool 26 is brought into meshed engagement with the work-piece. Specifically, the gear teeth of the chamfer/debur tool 26 engage the rough gear teeth of the work-piece. Initially, the chamfer/debur tool 26 is rotatably driven in a first direction whereby the chamfer surfaces 98 displace material at both ends of the rough gear teeth and the displaced material is cut away by the corresponding skiving discs 100. As the chamfer/debur tool 26 rotates, the meshed engagement with the work-piece causes corresponding rotation of the work-piece. As an alternative, it is anticipated that the work-piece can drive the chamfer/debur tool 26 or rotation of each can be controlled in a synchronized manner. The rotation of the chamfer/debur tool 26 then ceases and changes direction, rotating in a second direction. In this manner, chamfers are formed at the ends of each of the rough gear teeth about the circumference of the work-piece and excess material is cut away on both sides of each gear tooth. Upon completion of the chamfer/debur process, the chamfer/debur tool 26 is withdrawn from the work-piece.

During operation of the chamfer/debur tool 26 on the work-piece, the fourth stock 20 is concurrently repositioned on the third stock 18 to prepare the hob/shave tool 22 for a subsequent shaving process. The fourth stock 20 rotates approximately 90° on the front face 64 of the third stock 18, whereby the rotational axis B is positioned generally parallel to the rotational axis C and generally perpendicular to the top surface 30 of the base 12. In this manner, the shaver 82 is properly aligned for engagement with the work-piece. Concurrent repositioning of the fourth stock 20 helps to reduce overall cycle time of the manufacturing process.

Once the chamfer/debur tool 26 is completely withdrawn, the first stock 14 again moves forward along the axis X and the third stock 18 is concurrently adjusted on the Z axis whereby the shaver 82 of the hob/shave tool 22 is aligned for meshed engagement with the work-piece. The serrated teeth 86 of the shaver 82 engage the rough gear teeth of the work-piece. The hob/shave tool 22 is initially driven in a first rotational direction by the fourth stock 20, whereby the work-piece is correspondingly caused to rotate, due to the meshed engagement therebetween. Similar to the chamfer/debur tool 26, the shaver 82 stops and rotates in a second direction opposite that of the first. This “reversal” process is repeated a number of times based upon factors including, but not limited to the tool geometry. For example, the reversal process can be repeated twice more for a total of six times, three in each direction. As the shaver 82 and work-piece rotate together, each of the serrated gear teeth 86 of the shaver 82 act upon the rough gear teeth of the work-piece for finishing both sides of each gear tooth of the work-piece. Upon completion of the shaving process, the hob/shave tool 22 is withdrawn and the finished gear is unloaded from the retention device 28.

As initially noted, the apparatus of the present disclosure includes four manufacturing processes. By performing four-processes, only a single machine need be purchased to produce a finished gear. Thus, significant savings are realized in initial capital investment costs. Additionally, a single machine occupies less floor space, requires less maintenance attention and less running costs, than multiple machines. Therefore, additional savings are achieved throughout the lifetime of the machine. Further, overall cycle-time is significantly reduced because a component is only loaded and unloaded once and there is no transfer time present between machines. The reduced cycle-time translates into further cost savings.

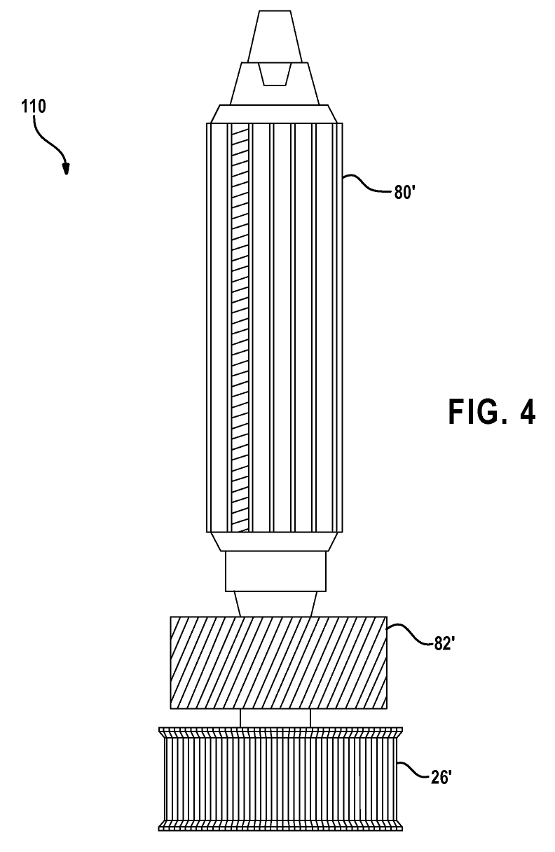

Referring now to FIG. 4, a combination hob/shave and chamfer/debur tool 110 is illustrated. The combination hob/shave and chamfer/debur tool 110 includes a hob 80′, a shaver 82′ and a chamfer/debur tool 26′, which are fixed for rotation together along a common axis. It should be noted, however, that detachment of the hob 80′, the shaver 82′ and the a chamfer/debur tool 26′ is anticipated, whereby a portion of the combination tool 110 may be replaced if worn before the another portion. The hob 80′ is and the shaver 82′ are similarly constructed as respectively discussed above with regard to the hob 80′ and the shaver 82′. Additionally, chamfer/debur tool 26′ is similarly constructed as discussed above with regard to the chamfer/debur tool 26.

The combination tool 110 can be implemented with the apparatus 10. Initially, a work-piece, in the form of a cylindrical gear blank, is loaded into the retention device 28 of the second stock 16. Once locked in position, the controller initiates the hobbing step, as discussed in detail above. As the hob teeth 84 cut the helical pattern of the gear teeth, the work-piece rotates about the axis C. As discussed above, the hob/shave tool 22 and the work-piece can be individually driven in a synchronized manner. In this manner, the gear teeth are cut into the complete circumferential surface of the work-piece. Upon completion of rough gear tooth formation, the hob 80′ is withdrawn through reverse movement of the first stock 14 along the axis X, relative to the second stock 16.

After the hob 80′ has been withdrawn, the chamfer/debur tool 26′ is brought into meshed engagement with the work-piece. This is achieved by manipulating the first stock 14 along the X axis, the third stock along the Z axis and the fourth stock 20 about the A axis. The fourth stock 20 rotates approximately 900 on the front face 64 of the third stock 18, whereby the rotational axis B is positioned generally parallel to the rotational axis C and generally perpendicular to the top surface 30 of the base 12. The gear teeth of the chamfer/debur tool 26′ engage the rough gear teeth of the work-piece and operate on the work-piece as described in detail above. After completing the chamfer/debur operation, the third stock 18 is repositioned on the first stock 14 to align the shaver 82′ for a subsequent shaving process. More specifically, the third stock 18 is adjusted along the Z axis to align the shaver 82′ with the work-piece. The serrated teeth 86 of the shaver 82 engage the rough gear teeth of the work-piece.

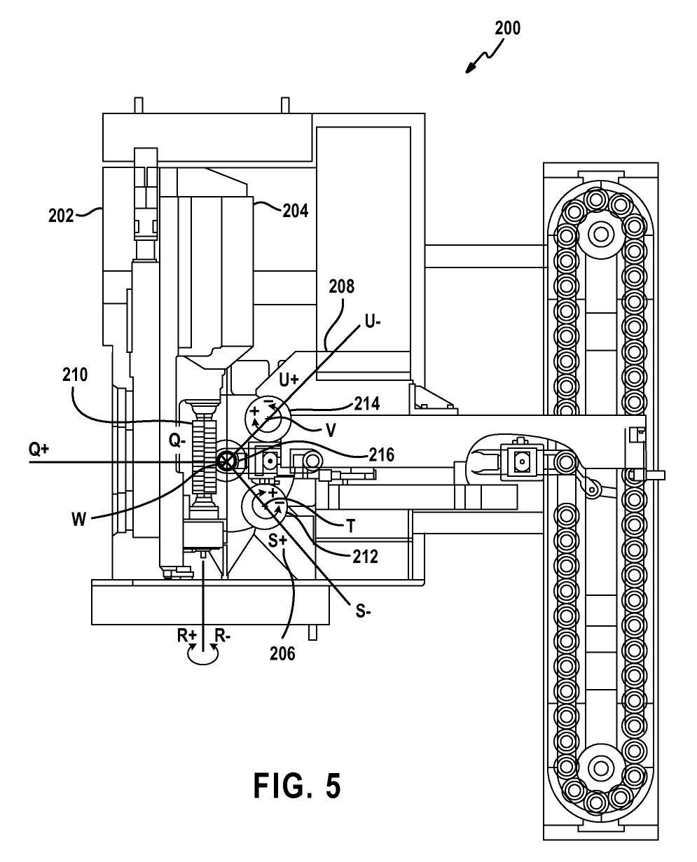

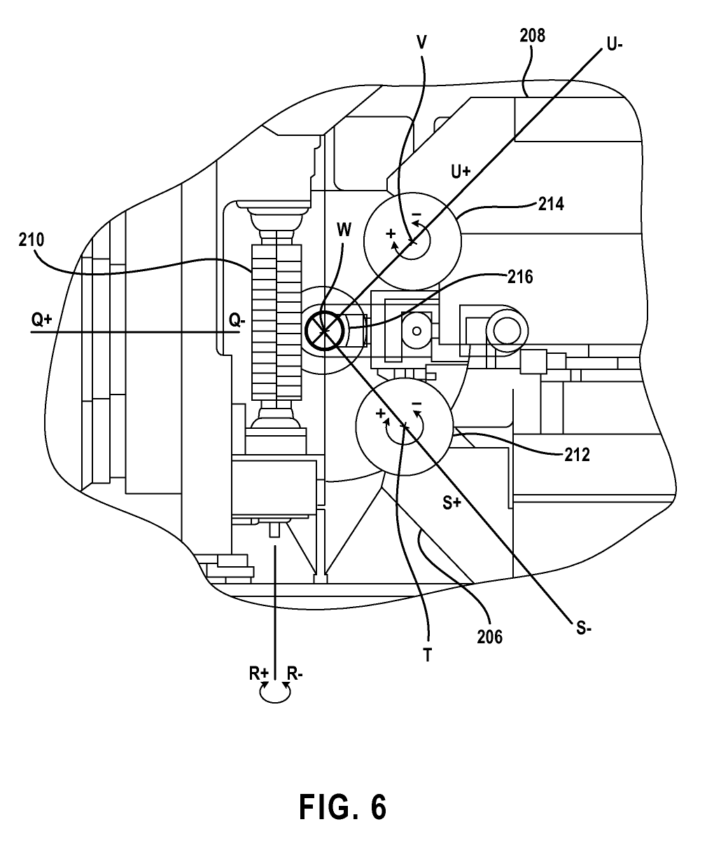

Referring now to FIGS. 5 and 6, an alternative multi-process manufacturing apparatus 200 (the apparatus) is shown. The apparatus 200 of the exemplary embodiment is provided for the manufacture of gears. However, it should be noted that the apparatus 200 is preferably variable for manufacture of any one of a number of alternative components. The apparatus 200 and its related components, described in detail below, are preferably CNC controlled by any one of a number of controllers (not shown) commonly known in the art. The controller is programmable for manufacturing a variety of components and/or component designs. It is foreseen that the controller is also programmable to simultaneously control operation of the rectilinear and rotary movement of the various stocks and spindles described herein.

The apparatus 200 includes a generally rectangular, solid metal base 202 providing a solid support structure for the various apparatus components described herein. First, second and third stocks 204,206,208, respectively, are included and are each slidably engaged with the base 12. The first stock 204 is linearly movable along a line Q and rotatably supports a hob 210 about an axis R. Axis R extends substantially parallel to the ground. The second stock 206 is linearly movable along a line S and supports a chamfer/debur tool 212 for rotation about an axis T. The third stock 208 is linearly movable along a line U and rotatably supports a shaver 214 about an axis V. Linear movement of the various sliding stocks described above is achieved by respective drive motors (not shown) that act through speed reducing gearing and/or recirculating ball screw drives (not shown), as similarly described in detail above with respect to the apparatus 10.

The apparatus 200 includes a retention device 216 for operably retaining a work-piece (not shown) for rotation about a work axis W during manufacture. Axis W extends substantially perpendicular to the ground. Lines S and U extend substantially parallel to the ground and intersect one another at axis W. The work-piece is rotatably driven about the axis W during specific machining operations, as described in further detail below. The work-piece can be rotatably driven by a motor (not shown). The hob 210 is rotatably driven about the axis R by a motor (not shown). The chamfer/debur tool 212 is freely supported about the axis T and is rotatably driven by the work-piece, as discussed in further detail below. Similarly, the shaver 214 is freely supported about the axis V and is rotatably driven by the work-piece. Concentricity errors in the manufactured gear are eliminated or at least reduced because the gear is retained by a single retention device 216 during each of the manufacturing operations.

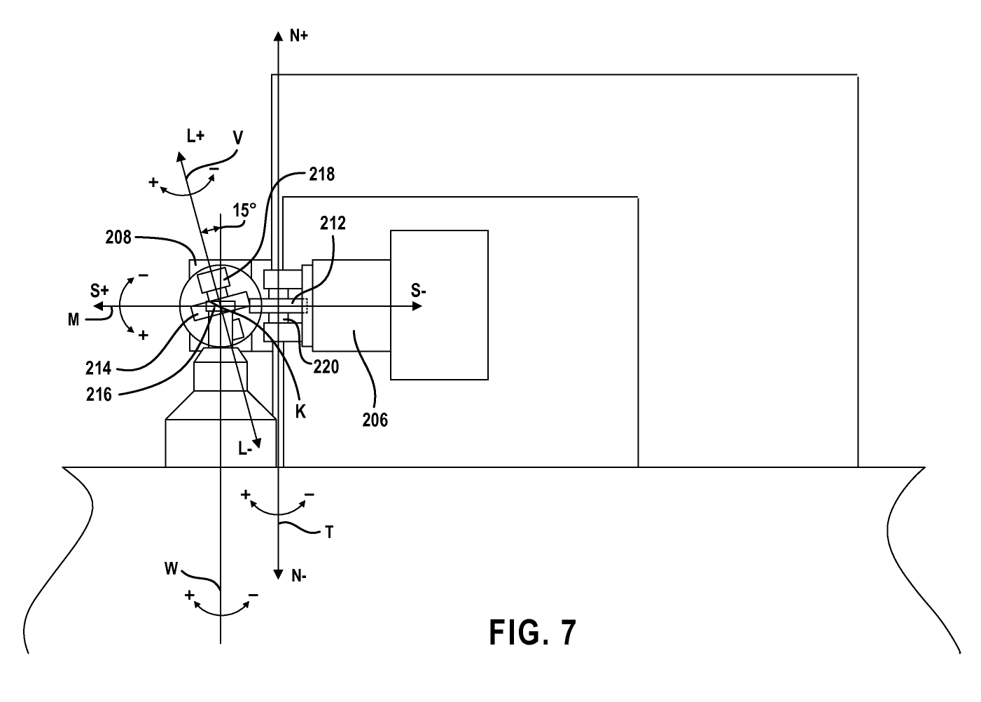

As shown in FIG. 7, shaver 214 is mounted on a spindle 218 rotatable about axis V. Spindle 218 and shaver 214 are provided with two additional degrees of freedom to optimize the contact between the work-piece and shaver 214. Accordingly, spindle 218 and axis of rotation V are rotatable about an axis K. Axis K intersects work axis W and extends substantially parallel to the ground. Axis V is depicted in FIG. 7 as being rotated −15° about axis K. Spindle 218 and shaver 214 are also linearly translatable along axis V in directions indicated as L+ and L−.

In similar fashion, chamfer/debur tool 212 is mounted on a spindle 220 rotatable about axis T. Spindle 220 and chamfer/debur tool 212 are provided with two additional degrees of freedom as well. Spindle 220 and axis of rotation T are rotatable about an axis M. Axis M intersects work axis W and extends substantially parallel to the ground. Axis T is depicted in FIG. 7 as extending substantially perpendicular to the ground but may be positioned anywhere along 360° of rotation about axis M. Both spindle 218 and spindle 220 have nominal positions where axes V and T extend perpendicular to the ground. An articulation range of plus or minus 45° from the nominal position is contemplated as being sufficient. Spindle 220 and chamfer/debur tool 212 are also linearly translatable along axis T in directions indicated as N+ and N−, as well.

With reference to the Figures, a method of manufacturing a gear and the corresponding operation of the apparatus 200 will be described in detail. Manufacturing of a gear includes the steps of: loading a gear blank (work-piece), hobbing rough gear teeth into the work-piece, chamfering and deburring the rough gear-teeth, finishing the gear teeth via shaving, and unloading the finished work-piece.

Initially, a work-piece, in the form of a cylindrical gear blank, is loaded into the retention device 216. Once locked in position, the controller initiates the hobbing step, whereby the hob 210 is rotatably driven and fed into contact with the work-piece for forming rough gear teeth in the work-piece. The preferred feeding method of the present disclosure is infeed or plunge. The hob 210 is infed via forward movement of the first stock 204 along line Q. As the hob 210 contacts a circumferential surface of the work-piece, the hob teeth begin cutting corresponding teeth into the circumferential surface. As the hob teeth cut the helical pattern of the gear teeth, the work-piece rotates about the axis W. Again, the hob tool 210 and the work-piece can be individually driven in a synchronized manner. In this manner, the gear teeth are cut into the complete circumferential surface of the work-piece. The number of revolutions of the hob 210, and thus the work-piece, is dependent upon the number of threads of the hob 210. Upon completion of rough gear tooth formation, the hob 210 is withdrawn through reverse movement of the first stock 204 along line Q.

After the hob 210 has been withdrawn, spindle 218 and chamfer/debur tool 212 are rotated to a desired position. If crossed axis engagement is desired, spindle 218 is rotated a predetermined amount, such as −15°, as shown in FIG. 7. The axial position of tool 212 along axis V may also be set at this time. Chamfer/debur tool 212 is next brought into meshed engagement with the work-piece via movement of the second stock 206 along line S. Specifically, the gear teeth of the chamfer/debur tool 212 engage the rough gear teeth of the work-piece. The work-piece is rotatably driven about the axis W, thereby driving the chamfer/debur tool about the axis T. Initially, the chamfer/debur tool 212 is rotatably driven in a first direction whereby the chamfer surfaces displace material at both ends of the rough gear teeth and the displaced material is cut away by the corresponding skiving discs. The chamfer/debur tool 212 is then driven in a second direction about the axis T, opposite the first direction. In this manner, chamfers are formed at the ends of each of the rough gear teeth about the circumference of the work-piece and excess material is cut away on both sides of each gear tooth. Upon completion of the chamfer/debur process, the chamfer/debur tool 212 is withdrawn from the work-piece.

Once the chamfer/debur tool 212 is completely withdrawn, spindle 220 is rotated and/or translated to move shaver 214 to a desired position. As previously noted, the preferred method of feeding is infeed or plunge. This method requires varying the position of third stock 208 along line U with the position of spindle 218 being fixed. An alternate conventional method may require more complex simultaneous movement of spindle 218 and stock 208.

To continue the plunge machining process, the third stock 208 moves forward along line U to bring the shaver 214 into meshed engagement with the work-piece. It should be appreciated that first, second and third stocks 204, 206 208 are moveable along a common plane or substantially parallel planes. The serrated teeth of the shaver 214 engage the rough gear teeth of the work-piece. The shaver 214 is initially driven in a first rotational direction about the axis V by the work-piece. Similar to the chamfer/debur tool 212, the shaver 214 is stopped and induced to rotate in a second direction opposite that of the first by the work-piece. This “reversal” process is repeated a number of times based upon factors including, but not limited to the tool geometry. For example, the reversal process can be repeated twice more for a total of six times, three in each direction. As the shaver 214 and work-piece rotate together, each of the serrated gear teeth of the shaver 82 act upon the rough gear teeth of the work-piece for finishing both sides of each gear tooth of the work-piece. Upon completion of the shaving process, the shaver 214 is withdrawn and the finished gear is unloaded from the retention device 216.

It is appreciated that the apparatus 200 is not limited to performing the processes described herein (e.g., hob, chamfer, debur and shave). Alternative processes and corresponding tools can be implemented. For example, a honing process and honing tool or a rolling process and rolling tool can substitute for the shaving process and shaving tool. The honing tool includes abrasive surfaces that work corresponding surfaces of the work-piece. The rolling tool includes surfaces that displace and polish corresponding surfaces of the work-piece. Furthermore, it should be appreciated that the movement of each of first stock 204, second stock 206, third stock 208, spindle 218 and spindle 220 may be coordinated by computer numerical control.

Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

What is claimed is:

1. A gear production apparatus for producing a gear from a blank, comprising:
a blank retainer rotatably supporting and selectively driving the blank about a work axis,
an axially moveable first stock supporting a first tool for rotation about a first axis, said first axis extending substantially perpendicular to said work axis; and
an axially moveable second stock supporting a second tool for rotation about a second axis, said second tool being moveable in two additional degrees of freedom such that said second axis is rotatable about a third axis and said second tool is axially translatable along said second axis, said second tool being moveable with said second stock along a line extending substantially perpendicular to and intersecting said work axis, wherein said first stock is moveable to engage said first tool with the blank to form rough teeth in the blank and wherein said second stock is moveable to engage said second tool with the blank.

2. The gear production apparatus of claim 1 further including a third stock supporting a third tool for rotation about a fourth axis, said third tool being moveable in two additional degrees of freedom such that said fourth axis is rotatable about a fifth axis and said third tool is axially translatable along said third axis, wherein said third stock moves along a line intersecting said work axis to engage said third tool with said blank.

3. The gear production apparatus of claim 2 wherein said lines that said second and third stocks move along are coplanar.

4. The gear production apparatus of claim 1 wherein said first tool is a hob.

5. The gear production apparatus of claim 1 wherein said second tool is a chamfer and deburring tool.

6. The gear production apparatus of claim 2 wherein said third tool is a shaver.

7. The gear production apparatus of claim 1 wherein said lines that said second and third stocks move along are radially separated by an angle ranging from 45-135 degrees.

8. The gear production apparatus of claim 1 wherein said first stock is moveable along a line that lies in a plane parallel to a plane containing said lines that said second and third stocks move along.

9. A gear production apparatus for producing a gear from a blank, comprising:
a blank retainer supporting the blank for rotation about a work axis,
an axially moveable first stock supporting a first tool for rotation about a first axis extending substantially perpendicular to said work axis;
an axially moveable second stock including an independently moveable first spindle supporting a second tool for rotation about a second axis, said first spindle being rotatable about a third axis, said first spindle also being axially translatable along said second axis; and
an axially moveable third stock including an independently moveable second spindle supporting a third tool for rotation about a fourth axis, said second spindle being axially translatable along said fourth axis and rotatable about a fifth axis, said first stock being moveable to engage said first tool with the blank to form rough teeth in the blank, said second stock being moveable to engage said second tool with the blank, and said third stock being moveable to engage said third tool with the blank.

10. The gear production apparatus of claim 9 wherein said third axis and said fifth axis each intersect said work axis.

11. The gear production apparatus of claim 10 wherein said work axis extends substantially perpendicular to the ground.

12. The gear production apparatus of claim 11 wherein said first axis extends substantially parallel to the ground.

13. The gear production apparatus of claim 12 wherein said second axis is positionable to extend substantially perpendicular to the ground.

14. The gear production apparatus of claim 13 wherein said fourth axis is positionable to extend substantially perpendicular to the ground.

15. The gear production apparatus of claim 14 wherein said third axis and said fifth axis extend substantially parallel to the ground.

16. The gear production of apparatus of claim 9 wherein each of said first, second and third stocks are axially moveable along one of a common plane or parallel planes.

17. The gear production apparatus of claim 9 wherein movement of each of the first, second and third stocks and the first and second spindles is coordinated by computer numerical control.

18. The gear production apparatus of claim 9 wherein said first and second spindles are nominally oriented to position said second and fourth axes substantially perpendicular to the ground.

19. The gear production apparatus of claim 18 wherein said first and second spindles are rotatable plus and minus 45 degrees from said nominal orientation.
